(19) United States
(12) Patent Application Publication
(10) Pub. No.: US 2015/0375192 A1
(43) Pub. Date: Dec. 31, 2015

(54) Commercial-Scale Gamma Radiation Carbon Dioxide Reduction

(71) Applicant: Peter Livingston, Palos Verdes Estates, CA (US)

(72) Inventor: Peter Livingston, Palos Verdes Estates, CA (US)

(21) Appl. No.: 14/751,053

(22) Filed: Jun. 25, 2015

Related U.S. Application Data
(60) Provisional application No. 62/017,172, filed on Jun. 25, 2014.

(51) Int. Cl. B01J 19/08

(52) U.S. Cl. CPC B01J 19/082; B01J 2219/0875

(57) ABSTRACT

The present system provides a reactor vessel for reducing a mixture of carbon dioxide and a reactant to a product by exposure to gamma radiation from spent fuel rods. The reactor vessel is constructed of a material that permits a substantial portion of the incident gamma radiation to pass through the wall, such as carbon fiber, silicon, or other low-Z material. An inlet tube introduces a mixture of carbon dioxide and a reactant into the interior of the vessel, where the mixture flows through the vessel to expose the mixture to gamma radiation to reduce the mixture to at least one product. In this way, spent radioactive fuel rods can be utilized for carbon dioxide reduction and for the production of useful chemicals.

### RELATED U.S. APPLICATION DATA

This application claims the benefit of the filing date of provisional application No. 62/017,172, filed on Jun. 25, 2014.

### BACKGROUND

Carbon dioxide (CO₂) is an atmospheric pollutant produced in great quantities by the power generation, cement, transportation and other made-made sources. Thus, private industry and governments have explored methods of capturing, offsetting, or otherwise decreasing the amount of carbon introduced into the atmosphere. Moreover, the US will likely mandate carbon capture and sequestration in the near future.

However, carbon capture and sequestration is currently very difficult and expensive using existing technology. For example, capturing carbon dioxide emitted by older coal-fired power plants is estimated to require approximately 30% of the plant's electrical capacity. Thereafter, the liquid state carbon dioxide would be injected into deep wells for storage. Environmentalists and others are concerned about leakage and seismic disturbances similar to those observed in “fracking” oil recovery.

Alternate capture techniques suggested involve conversion of the carbon dioxide into useful materials, such as plastics, fertilizer, paints, industrial chemicals, and pharmaceuticals. The carbon dioxide could be stored in the form of these materials over a long period of time, to prevent emission into the atmosphere.

However, reducing carbon dioxide to useful chemicals in commercial quantities has proven very difficult. In fact, there are no such processes in place, in spite of diverse efforts to reduce the molecule in electrolyte solutions, and over catalysts, and so forth. A problem common to all these reaction methods is that they are conducted in thermodynamic equilibrium leading to poor yields, low yield rates, and extensive back reactions.

Therefore, many government organizations and private industry are actively seeking better methods for offsetting and reducing carbon emissions. What is needed, is a method and system that can convert carbon dioxide to useful materials relatively inexpensively. What is also needed is a method and system for converting carbon dioxide to useful chemicals in commercial quantities.

### SUMMARY

The present method and system is directed to a process that reduces carbon dioxide pollutants into useful chemicals at commercial quantities. One embodiment of the present process comprises (1) positioning a radiation-transparent reaction vessel within an intense gamma radiation field, preferably in the vicinity of one or more waste fuel rods or assemblies within a cooling pond, (2) mixing a reactant with carbon dioxide, (3) flowing the reactant and carbon dioxide mixture through the radiation-transparent reaction vessel to expose the mixture to the gamma radiation field so that the mixture reacts to permit the reduction of carbon dioxide, (4) retrieving the reacted mixture and separating products from remaining reactants, (5) recycling remaining reactants back into the reaction vessel, and (6) storing the product chemicals in tanks available for transportation.

A first embodiment is a reactor vessel for reducing a mixture of carbon dioxide and a reactant to a product by exposure to gamma radiation. The reactor vessel has a wall enclosing an interior space, where the wall is constructed of a material that permits a substantial portion of the incident gamma radiation to pass through the wall. An inlet tube is included for introducing the mixture of carbon dioxide and the reactant into the interior space. An outlet tube is included for transporting the product out of the interior space. At least a portion of the wall is configured to be in sufficient proximity to a gamma radiation source for reacting the mixture flowing through the interior space from the inlet tube to the outlet tube. The distance between the wall and the gamma radiation source varies approximately between 1 and 10 centimeters.

Optionally, at least a portion of the wall is comprised of one of a carbon fiber material and a silicon material. Again optionally, the wall is made of the carbon fiber material, and an optical fiber strain sensor is wrapped about at least a portion of the wall, and is embedded within the carbon fiber material. As an option, the wall is substantially cylindrical in shape and has a bottom portion.

Optionally, the inlet tube extends into the interior space and towards the bottom portion. An open end of the inlet tube terminates at a distance from the bottom portion, the distance being sufficient to substantially reduce acoustic vibration due to turbulence, which may be approximately ten times a diameter of the inlet tube. Optionally, a bushing is positioned between an interior surface of the wall and an outer diameter of the inlet tube, where the bushing damps vibration of the inlet tube. The bushing has an inner ring, an outer ring, and a plurality of spokes connecting the inner ring to the outer ring, where the inner ring is fitted about the outer diameter of the inlet tube and the outer ring is fitted against the interior surface of the wall, to substantially prevent movement of the inlet tube.

As an option, the wall of the reactor vessel may be made of carbon fiber with a polymer coating on an interior surface of the wall and a fiberglass wrap on an exterior surface of the wall. The wall may be constructed of a material that substantially transparent to gamma radiation.

A method of reducing carbon dioxide and a reactant into a product is also presented. The steps of the method may include providing a reactor vessel comprising a wall that us substantially transparent to gamma radiation and enclosing an interior space, an inlet tube, and an outlet tube; locating the reactor vessel in proximity to at least one radioactive fuel rod; mixing carbon dioxide with a reactant to create a mixture; flowing the mixture through the inlet tube and into the interior space; reacting the mixture with the gamma radiation emitted by the radioactive fuel rod to produce a product; and flowing the product out of the interior space through the outlet tube.

Optionally, the reactor vessel may be an elongated cylinder with a bottom portion, the inlet tube extends into the interior space and towards the bottom portion, where an open end of the inlet tube terminates at a distance from the bottom portion.

An optional step may include locating the reactor vessel within an array of radioactive fuel rods, where the reactor vessel is positioned sufficiently close for adequate exposure to the gamma radiation to permit a reaction between the carbon dioxide and the reactant, and the reactor vessel being positioned sufficiently distant to provide space for cooling water flow between the reactor vessel and each of the radioactive fuel rods with the array of radioactive fuel rods.

Optional steps may include flowing the mixture through the inlet tube and out of the open end; reversing a flow direction of the mixture once exiting the open end; and flowing the mixture between an interior surface of the wall and an outer diameter of the inlet tube before the step of flowing the product out of the interior space through the outlet tube. Yet another optional step may include transporting the product to a water separator for extracting water.

An optional safety method may include the steps of embedding within the carbon fiber material an optical fiber strain sensor; sensing a failure event; activating an emergency control valve to substantially empty the reactor vessel of one or all of the carbon dioxide, the reactant, and the product; and transporting one or all of the carbon dioxide, the reactant, and the product to the emergency dump tank.

Optionally, the reactant is hydrogen and the product is of carbon monoxide, or the reactant is one or more of an alkane and an alkene, and the product is one or more of carbon monoxide, alcohols, aldehydes, and ketones, or the reactant is one or more of secondary and tertiary alcohols, and the product is unsymmetrical ketones.

An advantage of the present process and system is that it is not limited by thermal equilibrium considerations. High energy gamma rays that do deposit in the reacting fluid eject relativistic Compton electrons that create heavy ionization trails. These paths are marked by many fragments of the reactants. In particular carbon dioxide is broken up into ionized carbon atoms, oxygen atoms and ions, ionized carbon monoxide, and electrons, as well as the other reactant chemical fragments. Most specifically oxygen is freed to immediately combine with the selected reactant, oxidizing the reactant, and thereby reducing the carbon oxidation state. The flow rate through the reactor and separation technology prevents or greatly reduces the back reaction.

A second advantage is that the primary energy for the carbon dioxide reduction derives not from the power grid (no matter how remote that would be) but from the gamma ray deposited energy. Therefore this method has a very small “carbon footprint” (limited to the electricity used to run compressors and measurement devices).

A third advantage is that the product is pure; meaning there is no catalyst-damaging sulfur contamination that exists in present chemical feedstock, such as with “syngas”. The European chemical giant BASF is heavily investing in means to de-sulfurize syngas to make it useful as a carbon monoxide source used in ammonia manufacture.

A fourth advantage is that an economic model of the process shows it to be highly profitable because of the existing, yet wasted, energy source and the price of the product chemicals relative to the reactant costs. Because the one embodiment of the present system's chemical conversion takes place at a nuclear power plant cooling pond, the power plant owner will be able to defray the high costs of the cooling pond.

A fifth advantage of this process is that it relieves, to some extent, the government's sequester expense.

A sixth advantage, is that with modification, a dry cask storage unit (designed to accept fuel rod assemblies for permanent underground storage) can be used to transport the spent fuel rod assemblies to a prepared site consisting of a deep well into which the assembly containing steel container is lowered. After the cask is safely covered by 20 feet of water, it is as accessible to radiation chemistry, much like the cooling pond embodiment above.

There are 65,000 metric tons of spent fuel rods in this country at present, 30% of which are in dry casks. This means that close to 1,000 casks are presently loaded with about 200 rod fuel assemblies. Each one of these casks can therefore be a center for chemical production.

### BRIEF DESCRIPTION OF THE SEVERAL VIEWS OF THE DRAWINGS

FIG. 1 is a process flow diagram of the present system;

FIG. 2 is a partial cross-sectional view of the reaction vessel top design, designating input and outlet pipes and the central siphon;

FIG. 3 is a cross-sectional view of the reaction vessel body from the threaded neck down;

FIGS. 4A-B are a side and top plan view of the bushing used to support the end of the siphon and to damp acoustic vibrations;

FIG. 5 is a process flow diagram representing a plant configuration specializing in the production of carbon monoxide;

FIG. 6 is a process flow diagram representing an alternative plant configuration which is maximized for methanol and acetone production;

FIG. 7 is a process flow diagram representing an alternative plant configuration designed to produce various ketones depending on the secondary or tertiary alcohols used as a reactant;

FIG. 8 is a cross-sectional view of a modified dry cask storage unit with a removable bottom plate;

FIGS. 9A-B are cross-sectional views of the modified cask, used to safely deposit a fuel rod assembly into a deep well and covered with water as a radiation shield;

FIG. 10 is a perspective view of an exemplary chemical plant erected over a large water pool with a number of fuel rod assemblies, where an assembly irradiates one or more reaction vessels;

FIGS. 11A-D are top and side views of an eight-reaction vessel unit assembled around a 17×17 array of fuel rods bundled into a square fuel assembly array, where alternate vessel connections are shown for 2, 4, and 8 vessels in series; and

FIG. 12 is a process flow diagram representing an alternative plant configuration.

### DESCRIPTION OF THE PREFERRED EMBODIMENTS

The detailed descriptions set forth below in connection with the appended drawings are intended as a description of embodiments of the invention, and is not intended to represent the only forms in which the present invention may be constructed and/or utilized. The descriptions set forth the structure and the sequence of steps for constructing and operating the invention in connection with the illustrated embodiments. It is to be understood, however, that the same or equivalent structures and steps may be accomplished by different embodiments that are also intended to be encompassed within the spirit and scope of the invention.

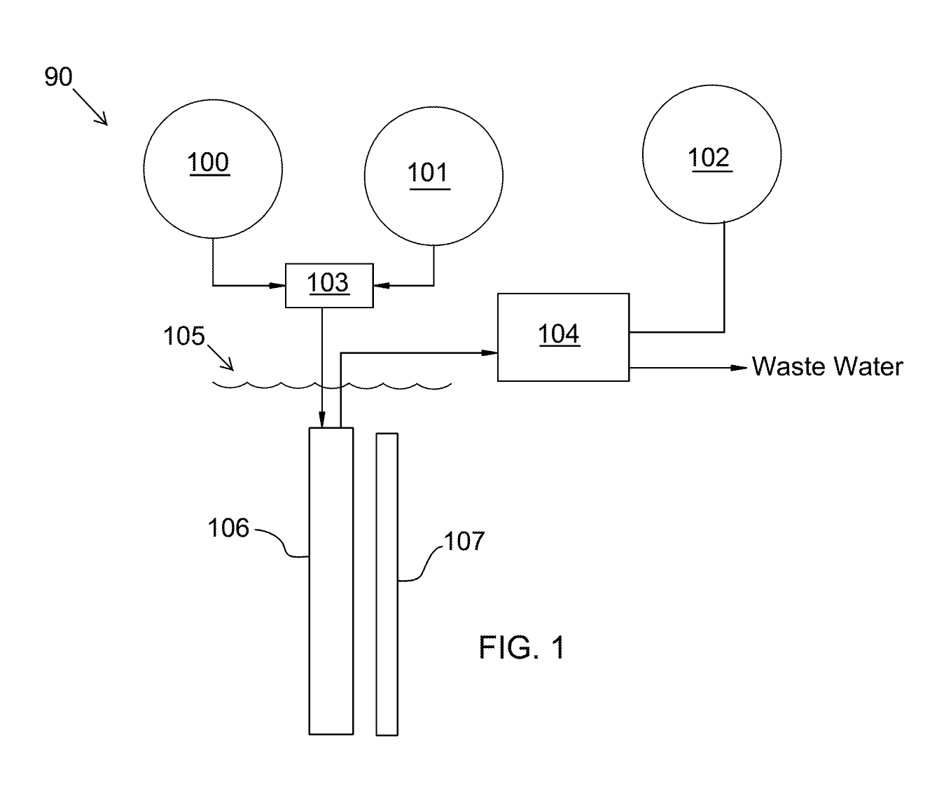

The process of reducing carbon dioxide by nuclear irradiation includes mixing the ingredients, subjecting them to an intense radiation field for a specific length of time; then separating out the products from any remaining reactants by means of the product separator. These general steps are illustrated in the plant (90) of FIG. 1. The reactants (100) and carbon dioxide (101), also a reactant, are stored in one or more tanks (most commonly in a “tank farm”), preferably located near the radiation source. However, the reactants may be transported to the radiation source through pipelines or other similar means. Gases are preferentially stored in liquid form and brought up to operating temperature through a heat exchanger. The gas mixture of carbon dioxide (101) and one or more reactants (100) exits the mixing chamber (103) at high pressure. If hydrogen is used as a reactant (100) and is mixed with carbon dioxide (101), the pressures are 144 and 100 atmospheres, respectively. These pressures were chosen based upon the trade between a sufficiently dense medium for gamma ray capture and a change of state occasioned by a carbon dioxide pressure being too close to the gas-liquid line in its phase diagram.

The reactor vessel (106) is preferably designed to be long and narrow, so that the reactor vessel (106) is positioned in close proximity to one or more fuel rods (107) in a fuel-rod assembly, but preferably not in physical contact with the fuel rods (107), the distance preferably being on the order of several centimeters, but might range from about 1 centimeter to 10 centimeters. Less than 1 centimeter is possible, but there must be sufficient distance to permit water to flow between the wall of the reactor vessel (106) and the fuel rods (107). A distance greater than 10 centimeters is also possible. However, space within the pool may limit the distance and the efficiency of the system would be reduced significantly with a larger distances.

Both the reactor vessel (106) and the fuel rods (107) are preferably submerged under water, in a cooling pond or similar body of water (105). Details of the reactor vessel (106) are revealed in subsequent drawings. There is about a centimeter of water between the rods (107) and the reactor vessel (106) to insure that the rods (107) are suitably cooled. Thus, the distance between the reactor vessel (106) and the fuel rods (107) should be distant enough to permit sufficient cooling of the fuel rods (107) by the water, yet close enough to insure adequate exposure to the gamma radiation. Since fuel rods (107) are often stored in close proximity in an arrayed configuration within the fuel-rod assemblies and the reactor vessel (106) is inserted between the fuel rods (107), the distance between the fuel rods (107) and the reactor vessel (106) is approximately one centimeter.

Following reaction in the vessel (106), the exit gases are separated in the separator (104) and then sent to a product storage tank (102). As will be apparent, there may be several separator options to accommodate the variety of chemical output options available. The general choices are membrane separation applied to pure carbon monoxide production, rapid expansion of the product gases through an orifice causing a fog followed by cyclone separation, and distillation that may be further subdivided into ordinary and azeotropic distillation or a combination of both. Many of the produced chemicals are miscible in water or alcohol (depending on the reactant choice), and therefore a second azeotropic distillation stage must be added. An azeotrope is a mixture of two miscible liquids that cannot be further separated by simple distillation. An example is a mixture of methanol and water that exists even after distilling over the low boiling point methanol fraction. Azeotropes are mixed with a water-immiscible solvent, such as benzene to extract the organic product. Then the benzene mixture is distilled over to separate out the anhydrous product and the benzene recycled.

Before going to the details of the reaction vessel and various plant configurations, it is useful to review the radiation chemistry. Radiation decomposition of carbon dioxide has been well understood and documented for nearly a half-century. For example, carbon dioxide was briefly considered as a coolant for early graphite pile nuclear reactors just after WWII. Gamma rays are stopped in any material by inelastically scattering from atomic electrons. The latter are often ejected as relativistic electrons (A Compton electron) along with lower energy gamma rays. These high speed electrons inelastically scatter from other atomic electrons producing gamma and x-rays (breaking or brehmsstrahlung radiation) and ejecting other electrons. Ultimately Compton electrons are slowed and stopped in the material in an intense trail of ionized particles. These ionized particles consist of molecular fragments, ions and electrons. For example, carbon dioxide decomposes as follows:

CO₂+e_{high speed}^{e-}→C⁺, O⁺, CO₂⁺, CO, O, e⁻ (1)

A similar decomposition occurs for the other reactant. Here, the most important and highly reactive fragment is the oxygen ion and atom. The other reactant is chosen to combine efficiently with it, thereby preventing an immediate back reaction.

A large number of chemical products can be produced by the radiation reduction of carbon dioxide along with a suitable reactant. Consider for example, hydrogen and this sequence of chemical reactions occurring in the presence of gamma radiation [γ]. One notices that the oxidation state of carbon is sequentially reduced from +4 to −4.

H₂+CO₂+[γ] [symbol] CO+H₂O

2H₂+CO₂+[γ]→H₂CO+H₂O

3H₂+CO₂+[γ]→CH₃OH+H₂O

4H₂+CO₂+[γ]→CH₄+2H₂O (2)

Carbon monoxide, formaldehyde, methanol, and methane are all produced by the reduction of carbon dioxide with hydrogen by means of gamma irradiation. The latter reaction is known as the Sabatier reaction. It should be noted that the forward reaction is exothermic, making the back reaction unlikely. The back reaction in the first equation (the “shift” reaction) is also energetically favored and is a common means for creating in situ hydrogen for use in ammonia production. This means that if CO is to be recovered as a product, it must be separated from water as quickly as possible. The other chemical reactions are less sensitive to back reaction.

This sequence of chemical reactions suggests that all of these products are produced by any molar ratio of hydrogen to carbon dioxide, but that the bulk is favored by the particular mole ratio. For example, a 3:1 molar ratio favors the production of wood alcohol. Note also that the product separator differs significantly. In the first case, one way of effecting product separation is to expand the high pressure gas mixture leaving the reaction vessel though a small nozzle causing the water vapor to condense, separating it from the carbon monoxide and any remaining reactant gases. If needed, it can be further dried and then chilled to its boiling temperature and stored as a liquid.

Formaldehyde and methanol are completely separated from water by azeotropic distillation, yielding the anhydrous product. Methane generally does not require any special separation. Pure carbon monoxide is rough-dried by rapidly expanding the product gases and cyclone-separating out the water mist. Then, the dried exit gas is forced forcing through a membrane filter designed just to pass carbon monoxide, yet block other gases. Such membranes exist for flue gas-CO₂ separation. The molecular structure of the membrane can be configured for the present carbon monoxide application.

Consider alkanes and alkenes to be an extension of hydrogen; that is H₂ is replaced by RH where R is the alkane or alkene radical. An example is R˜[CH₃]. Here is the set of reactions analogous to (2).

RH+CO₂+[γ]→CO+ROH

2RH+CO₂+[γ]→RHCO+ROH

3RH+CO₂+[γ]→R(CO)R+ROH (3)

Here ROH is the common product. Unlike reactions (2), both products are commercially valuable: the alcohol, ethanol, propanol, and the like; and aldehydes (RHCO); and the symmetrical ketones, R(CO)R.

Other reaction choices are also available. For example, when an unsymmetrical alcohol reacts with carbon dioxide in a radiation field, an unsymmetrical ketone is produced.

RR′HCOH+CO₂+[γ] [symbol] CO+R(CO)R′+H₂O (4)

But just as in reaction (1), the shift reaction may occur in which water combines with carbon monoxide to produce hydrogen and carbon dioxide. Hence, the CO and H₂O must be separated as rapidly and completely as possible for a significant product yield.

These examples by no means exhausts the cornucopia of chemical possibilities, it is possible to consider the reactant MH where M is a member of the fluorine family (M=F, Cl, Br, I). In this case the reaction becomes:

2MH+CO₂+[γ]→M(CO)M+H₂O (5)

For M=Cl, the product is phosgene, a useful starting material for plastics.

All of these chemicals are created in highly non-thermal equilibrium media and their energy distributions cannot be described by a temperature. Specifically there are far more high energy fragments than described by a single temperature Boltzmann distribution, and therefore the production rates can be much higher than even catalyzed standard reactions.

Log-log plots of fragment numbers versus the energy of the initial Compton electron or gamma ray are generally linear and their slope is termed the G value described as the number of fragments produced per 100 eV of the initial relativistic electron.

Researchers in industry have measured G-values for all of the above reactions using a monochromatic cobalt 60 radiation source (1.3 MeV photons) and found numbers in the range 3 to 4. This means that each 1.3 MeV photon that deposits will produce on average between 39,000 and 52,000 daughter products. Quoting the paper Gamma radiolysis of carbon dioxide, “extremely large amounts of ketones are produced in the mixtures of carbon dioxide with secondary or tertiary alcohols.” (Bull. Korean Chem. Soc., Vol. 9, Nr. 1, 1988 pp 55-59). The mechanism is ascribed to the differences in hydrogen atom extraction from the alcohols dependent on which carbon atom the hydrogen was attached to—the so-called alpha and beta hydrogens. In these experiments aldehydes were expected but not detected, arising perhaps from the fact that these compounds are unstable in heavy radiation fields.

Bear in mind that the Cobalt-60 radiation source has only one-millionth to one ten-millionth the radiant flux of a fuel rod. That is why this disclosure reveals a practical means to reduce carbon dioxide in massive quantities unlike laboratory experiments.

To find out how such an intense radiation source transforms reactants in the reaction vessel, a detailed numerical model was constructed in MATHCAD to connect chemical reaction rates with fuel rod gamma radiation. Also differing from the above research, the radiation source is broadband, consisting of strong line emitters and a brehmsstrahlung background. This spectrum covers the range from 1.8 MeV down to a few hundreds of volts. Moreover, the rod was assumed to have a total activity of 2.59×10²¹ becquerels (taken from a Fukushima rod measurement) and the mixed line and brehmsstrahlung spectrum of a Three Mile Island rod. Neutron radiation from the rod source was ignored, and only the gamma ray spectrum was considered. A simple tomographic calculation determined the deposited gamma energy within the reaction vessel taking into account the composition and dimensions of the reaction vessel wall.

Some years back SANDIA Corporation published an extensive set of Compton and photoelectric cross section data, from whence the cross sections for energy transfer for any molecule can be calculated. Similarly the National Institute of Standards and Technology published extensive stopping power tables.

An exemplary long, cylindrical reaction vessel (106), with an effective volume of 29 liters, is placed one centimeter away from the surface of the fuel rod (107), as shown in FIG. 1. Taking into account an effective cutoff threshold of about 9 KeV determined by the vessel walls, and assuming that the vessel is filled to carbon dioxide partial pressure of 100 atmospheres pressure and 144 atmospheres partial pressure of hydrogen (equimolar amounts), 2.8% of the molecules are broken up in one second. Hence, the reaction is essentially complete in 36 seconds. This datum and the vessel dimensions determine the flow rate. The flow rate is then 28.9 cm/sec and, again based on the vessel dimensions, the flow is turbulent.

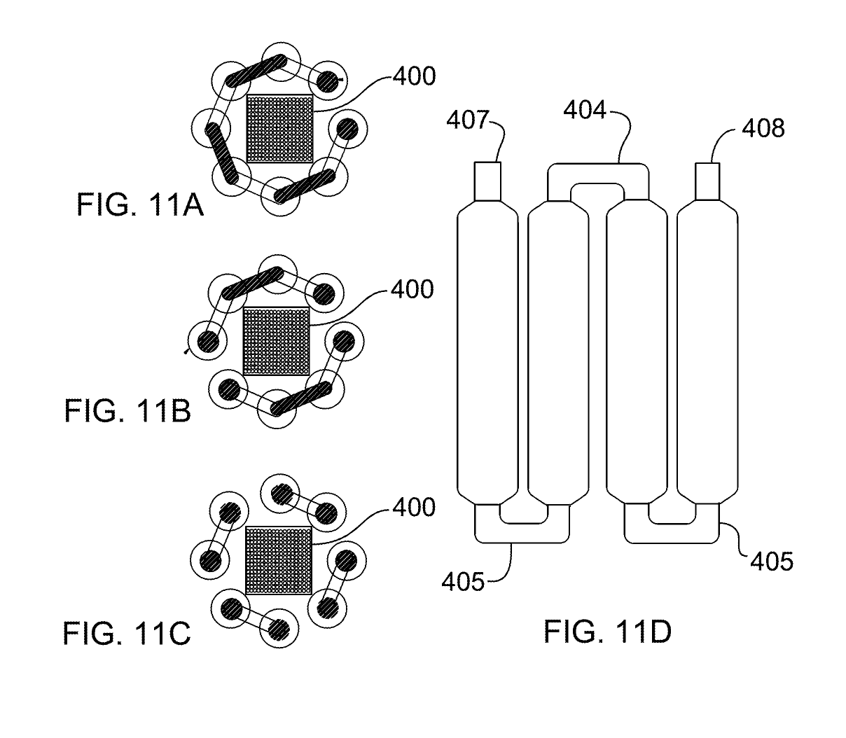

Although one reaction vessel (106) exposed to one fuel rod (107) is used in the calculation, it is appreciated that this arrangement is highly flexible. For example, the vessel (106) may be exposed to more than one rod (107) at a time. A typical fuel rod (107) assembly or array is a hexagonal or a square array, ranging from tens of rods to several hundred. A reaction vessel (106) centered in this fuel rod (107) array could receive a dose at least an order of magnitude larger than a single rod (107). Also if a greater dose is required, a plurality of reaction vessels (106) can be linked together like sausages in a chain, such that chemicals flowing from one reaction vessel will be immediately delivered into another reaction vessel for further exposure to gamma radiation. See discussion of FIG. 11 for further details.

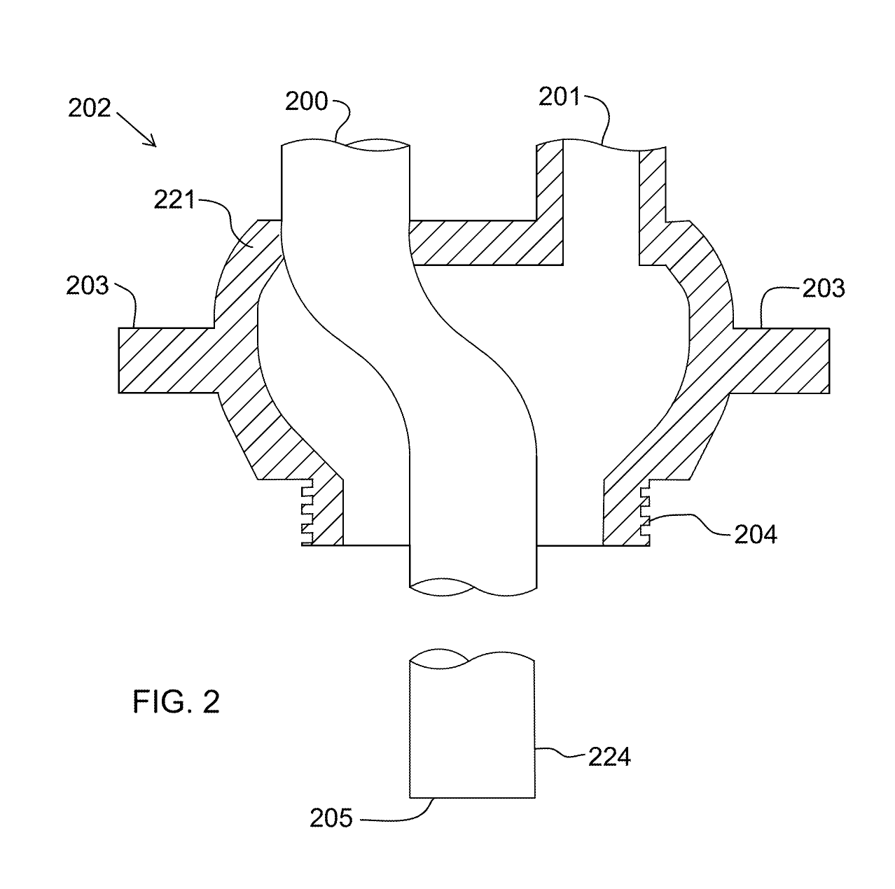

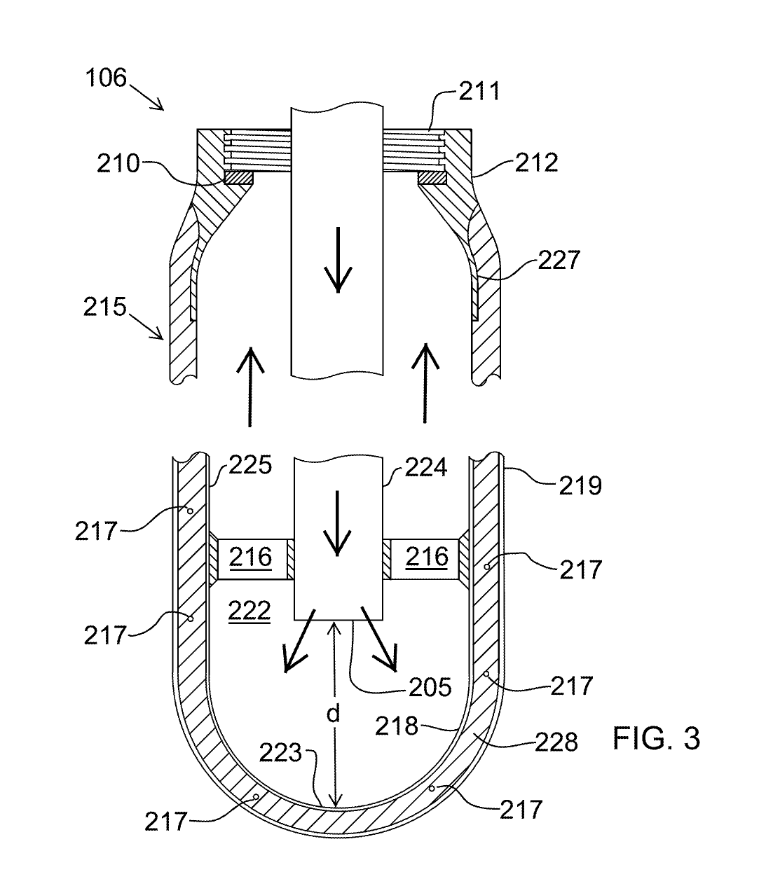

FIGS. 2 and 3 further describe construction of the reactor vessel (106). In general, the reactor vessel (106) body (215) is an elongated cylinder, similar to a high pressure gas cylinder or pressure vessel. In this exemplary embodiment, the reactor vessel (106) is 12 cm in diameter and 3.9 m long. This particular shape is configured to be positioned parallel to one or more fuel rods (107) and is about the same length as the as the fuel rods (107). The body (215) of the reactor vessel (106) has a female threaded neck (211) into which is screwed the male thread (204) of a cap (202) supporting a long siphon (205) that extends nearly the length of the vessel body (215).

The body (215) of the reactor vessel (206) is preferably made from carbon fiber impregnated resin, since this class of materials are made from low Z elements, such as carbon, oxygen, and nitrogen. Thus, the use of carbon fiber insures the reactor vessel (106) is maximally transparent to gamma rays, while being strong enough to contain the reaction gas pressures, where high transparency means there is low gamma ray attenuation for all gamma ray energies down to about 7 KeV. The cap body (221) is preferably made from a stainless steel alloy. Stainless steel is chosen because it will resist corrosion by the oxygen atoms freed when a gamma ray deposits somewhere in the electrons of a surrounding water molecule. Aluminum may be used, although it is susceptible to attack by oxygen atoms and is less desirable than stainless steel.

Projections or trunnions (203) protrude from the cap (202) to provide an attachment portion for raising and lowering the reactor vessel (106) into the cooling pond. An inlet pipe (200) extends though the body (221) of the cap (202), communicating between one or more external fluid sources and the interior (222) of the reactor body (215). When the cap (202) is threaded on the reactor body (215), the inlet pipe (200) extends into the interior (222) of the reactor body (215), extending almost to the bottom portion (223) of the body interior (222). The end (205) of the inlet pipe (200) is open to the interior (222) of the reactor body (215), so that fluids (gas or liquids) introduced into the reactor vessel (106) through the inlet pipe (200) flow downward through the inlet pipe (200) and exit the inlet pipe (200) at the end (205), near the reactor body (215) bottom portion (223). The fluid then flows upward around the outer diameter (224) of the inlet pipe (200) in the space between the inlet pipe (200) and the inner wall (225) of the reactor body (215). The fluid travels back towards the cap (202), exiting the cap (202) from the outlet pipe (201). In this way, gases or liquids will be exposed to the gamma radiation throughout the entire flow path (indicated by arrows), both downwards and back upwards. The inlet pipe (200) and the outlet pipe (201) may be connected to external resources through heavy-duty flexible hoses (not shown), to transport gases or fluids into or out of the reactor vessel (106). Depending the radiation environment, it may be necessary to displace the hoses slightly from a vertical alignment with the reaction vessel in order to prevent a ‘hole’ in the cooling pond water radiation shield through which gamma rays could escape.

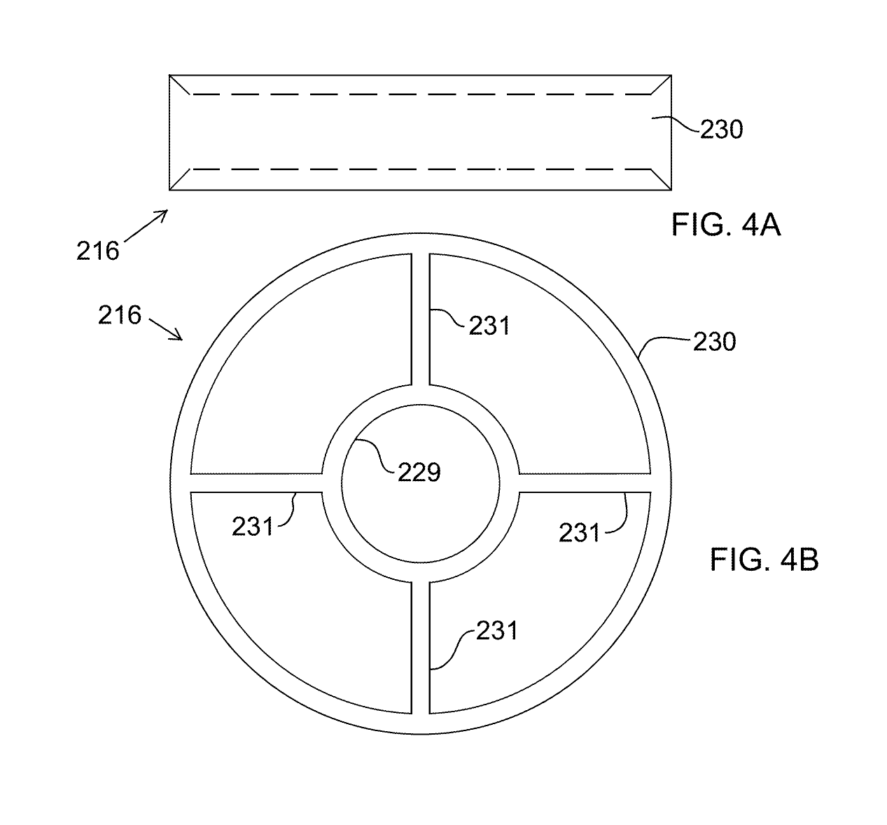

The reactor body (215) is shown more clearly in FIG. 3. From the top down, the mating female thread (211) ends at a gasket ring seal (210) seated on a shoulder of the stainless steel collar (212). The tube (214) is preferably made from 6061 aluminum with a 3 cm outer diameter. The lower portion (226) of the tube (214) is stabilized by a wagon-wheel support bushing (216), as shown in FIG. 4. The numerical model mentioned above reveals that at the operating pressure, the flow is turbulent with a Reynolds number of around 5000. Accordingly, the long tube (214), if undamped, would sound like an organ pipe at a low acoustic frequency excited by the turbulent eddy field at its exit. The wagon wheel bushing (216) dampens and limits the range of motion of the tube (214) preventing its eventual failure from metal fatigue.

The distance (d) from the end of the tube (214) to the reactor body (215) bottom is preferably about ten times the tube (214) diameter. Detailed flow analysis could change this number, but generally it is chosen to move the turbulent eddy field away from the pipe end to reduce the acoustic interaction mentioned above.

The reactor body (215) is created by winding a resin impregnated carbon fiber tape around a mandrel, preferably using known SCBA tank design and manufacture techniques modified for use in the present application. In the present reactor vessel (106) design, collar (212) is preferably made of stainless steel and has a female thread (211) with a gasket (210) to create a seal between the reactor body (215) and the cap (202). The collar (212) has a neck portion (227) that permits proper adherence of the carbon fiber to the collar (212), so that the reactor vessel (106) may hold pressure without bursting at the collar-reactor body connection. The neck portion (227) or shoulder of the collar (212) has an increasing diameter extending down into the carbon fiber vessel neck (213). This shoulder may be ribbed for increasing traction between the two pieces if needed. In this way, a maximum portion of the reactor body (215) can be made of carbon fiber to preserve the gamma radiation transparency of the reactor body (215).

The carbon fiber composite wall (228) of the reactor body (215) is preferably 1 cm thick and is in accord with analysis referenced below. In the case of hydrogen and carbon dioxide at a total pressure of 244 atmospheres (373 degrees Kelvin), the pressure is about 3586 psi. SCBA tanks are routinely pressurized to 4500 psi and have been shown to burst at 15,000 psi. Finite element analysis of a carbon fiber tank (Sulaiman, et al, Finite element analysis of a filament-wound composite pressure vessel under pressure, 2^{nd} International Conference on Mechanical Engineering Research (ICMER2013) IOP Publishing IOP Conf. Series: Materials Science and Engineering 50 (2013)) teaches that a wall thickness of 10% of the diameter was sufficiently strong. Moreover it was found that a tape winding angle of 55° provided maximum strength. High pressure hydrogen is routinely stored in composite fiber tanks and therefore the interior dense polyethylene polymer interior coating (218) may not be necessary, but is included in the present design to prevent hydrogen seepage through the wall. An outer protective fiberglass wrap (219) insures the vessel's safety and protects the built-in optical fiber strain gauges (217).

Although a potential burst pressure is approximately 15,000 psi and the present expected operating pressure is only 27% of the burst pressure (for the production of carbon monoxide, where other higher mole ratios of hydrogen to carbon dioxide involve increasing pressures and decreasing throughput to remain in a safe pressure zone), a catastrophic vessel failure would result in a large bubble chain that could permit gamma radiation to escape the pond. Unlike metal containers that would embrittle and shatter with continued exposure to gamma radiation, a carbon-fiber vessel failure is likely to be a tear.

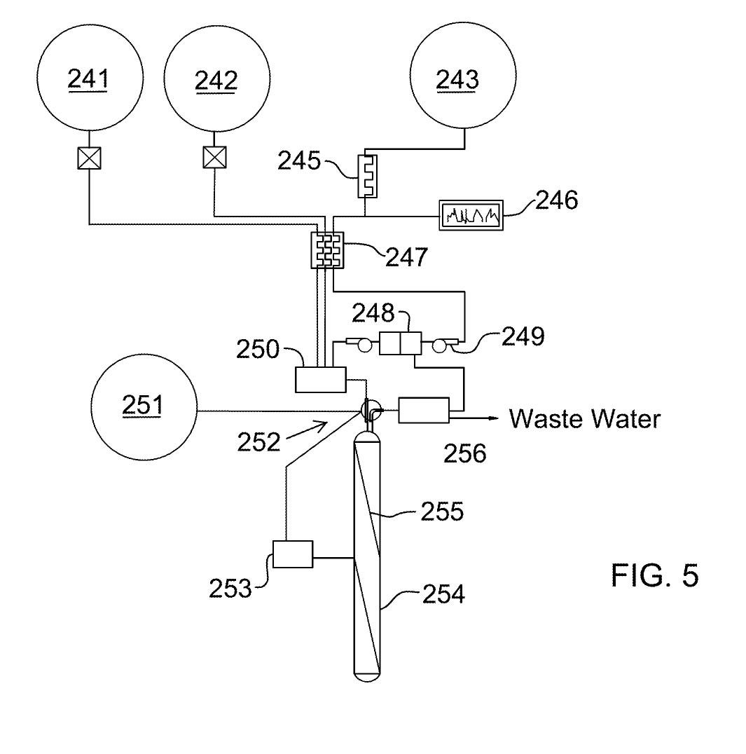

Electrical strain gauges may be used to detect and prevent failure at an early stage, but may be unsuitable in the present application, as they are strongly affected by the radiation field. The present reactor vessel (106) utilizes an optical fiber sensor (217) embedded within the carbon fiber composite wall (228), terminated in a Bragg reflector and placed as one arm in a Michelson interferometer to sense minute changes in the reactor vessel's (106) shape. FIGS. 3 and 5 show these embedded optical fibers (217) wound in two intertwined spirals around the vessel. Strain changes affect the length of the fiber and therefore the interference pattern created between its reflected optical signal and the reference signal. If an interference pattern shift is detected electronically back at a control center, an emergency vessel depressurization procedure is followed. It is probable that there will be detectable shape changes arising from sound waves in the vessel fluid, and average pressure change and so forth. These can be calibrated out, and therefore only the precursor to a catastrophic failure be detected. Radiation will darken fibers eventually but by proper choice of fiber materials free of heavy metals, it should be possible to make them last as long as the vessel.

The bushing (216) (shaped much like a wagon wheel) is shown in greater detail in FIG. 4. The preferred material is chemically inert Teflon that also is deformable, and therefore is a good vibration damper. The diameter of the bushing (216) is dimensioned for a tight fit to the reactor body (215) interior or inner wall (225). The bushing (216) impedes the flow of gas or liquid as little as possible due to the relatively large spaces between the spokes (231). Thus, the throughput area of the bushing (216) is approximately 83%. An inner ring (229) fits tightly about the outer diameter (224) of the inlet pipe (200) or siphon. The outer ring (230) fits tightly against the inner wall (225). The obstruction from the spokes (231) will decrease the flow rate somewhat, but is easily countered by slightly increasing the operating pressure. The flexibility of the Teflon wagon wheel bushing (216) also aids in the initial deployment of the tube (214). It can be twisted and bent to pass through the vessel neck and then expand and straighten when in place.

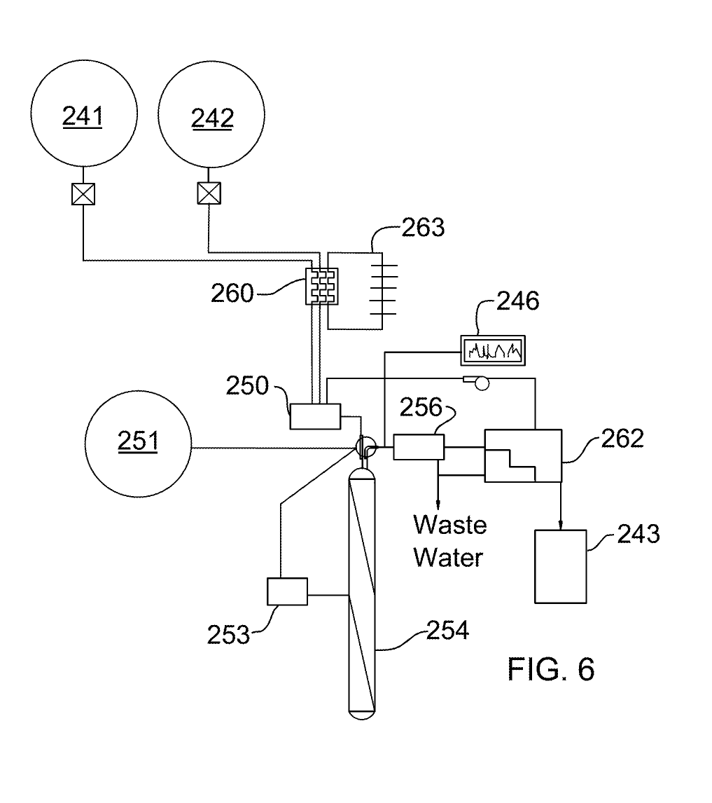

Three alternate embodiments of the present system are illustrated in FIGS. 5, 6, and 7, which are modified to produce carbon monoxide, methanol/acetone, and ketone, respectively. FIG. 5 illustrates the plant configuration to produce carbon monoxide from carbon dioxide and hydrogen. Both hydrogen in tank (241) and carbon dioxide in tank (242) are stored in liquid form to better accommodate the large plant throughput capacity. These gases and the output liquid carbon monoxide tank (243) are preferably located in a tank farm near the cooling pond. These tank farms are built to standard practice by known vendors, such as PRAXAIR, LIQUID AIR, and others. Both hydrogen and carbon dioxide are preferably reacted in gas form, and so the liquids should be brought up to the gaseous state by a heat exchanger (FIG. 6 illustrates a second product) that simultaneously warms streams of hydrogen and carbon dioxide, and also extracts heat from the product carbon monoxide before it is sent to a small refrigerator unit (245) that chills the gas to its liquid state.

An infrared spectrometer (246) monitors the purity of the output product. It is appreciated that there may be more monitoring instruments. For example, one monitor may sample the gas in the feed-back loop between the membrane separator (248) and the input mixing plenum (250).

After hydrogen and carbon dioxide are brought up to pressure and temperature, they are mixed together in the mixing plenum (250), along with a recycled mix of reactants that have passed through the reactor vessel (106) or reactants that result from a back reaction between the products carbon monoxide and water.

Following mixing, the reactants are fed into the reactor vessel (106) passing through a special emergency valve (252). Once entering the reactor vessel (106), the reactants are subject to an intense radiation field and decompose into various radicals. As mentioned above, this entire process has been numerically modeled with a vessel throughput flow rate of 28.9 cm/sec. Upon exiting the reactor vessel (106), the product gases are flowed into a water separator (256) where water is extracted. This should be done expeditiously to prevent the back reaction from occurring that would regenerate the reactants. It is appreciated that various technologies may be applied to the water extraction process and stating that it is a Joule-Thompson expansion orifice followed by a cyclone separator is exemplary in nature. For example, it may be that any easily hydrated substance that does not react with carbon monoxide could be used in its place. Moreover, the separator (256) choice will also depend on whether the yield is solely carbon monoxide or a richer mix of chemicals as alluded to earlier. In this case, the separator (256) may consist of stages to address the different separation requirements of each of the products. A further stage in the separation of carbon monoxide is the membrane separator (248). The membrane separator (248) is a molecular sieve that passes only the carbon monoxide molecule, but rejects others.

Emerging from this molecular sieve is a stream of pure carbon monoxide that is initially chilled in the heat exchanger (247) and further chilled in a refrigerator unit (245) and sent to storage (243) in liquid form. Compressors (249) are utilized to bring the exit gas either up to the input pressure or that needed to create a stream of liquid carbon monoxide.

Pure carbon monoxide is one feedstock gas needed for the production of ammonia. The latter reacts pure hydrogen and nitrogen in suitable conditions over a catalyst. These catalysts are easily rendered useless by sulfur contamination. Accordingly, the present source of carbon monoxide, derived from synthesis gas or syngas (a mixture of carbon monoxide, hydrogen and traces of a large variety of other materials), must be purified to remove catalyst poisons. This impure gas is derived from fossil fuel materials, either coal or oil, and carries with it sulfur compounds. In contrast, carbon monoxide produced by the disclosed process contains no contaminants and is directly suitable for use in the ammonia process or any other organic synthesis.

A waste product of the ammonia industry is carbon dioxide which is usually ejected to the atmosphere. The present system in conjunction with one or more ammonia plants would recycle the carbon dioxide by turning it into carbon monoxide, to produce ammonia, thus capturing the carbon dioxide. Since the gamma radiation is produced by the spent rods regardless, the energy invested into the conversion of carbon dioxide into carbon monoxide using the present system presents no additional costs and leaves little to no carbon footprint.

There is an extensive safety system attached to the reaction vessel (254). The safety system consists of a spiral wrap embedded optical fiber (255), the strain sensor (253), an evacuated dump tank (251), and an emergency control valve (252). As described above, the sensor is a Michelson interferometer with a laser diode light source. The sensor has two arms: a reference arm and one with the embedded optical fibers (255). The embedded optical fiber (255) is configured with a Bragg reflection grating at its end. The interference pattern between the reference arm and the embedded fiber (255) immediately reveals if there is any precursor or tear change in shape. If one is detected, the emergency control valve (252) is opened and the vessel (254) contents dumped into the emergency dump tank (251). The input flow is also cut off. This emergency depressurization prevents any tank rupture and allows the vessel (254) to be withdrawn and safety inspected. There are two such embedded optical fibers (255) as illustrated in the drawing. There is an interferometer sensor head associated with each one.

FIG. 6 illustrates a second product variant based on the second and third reactions shown in eq. 3 above. The first chemical reaction shown in eq. 3 shows that equal concentrations of an alkane, from tank (241), and carbon dioxide produces carbon monoxide and an alcohol. Therefore the physical plant is identical to FIG. 5, possibly with the exception of an additional separation stage to produce anhydrous alcohol. In contrast, the product here are alcohols, aldehydes and ketones produced by reacting alkane/alkene gas (methane, ethane, etc., ethane, propene, and the like) at ratios of two and three to one with carbon dioxide in the reaction vessel. The product then is isolated from the reactants in a two-step separation process.

The reactants used in the system illustrated in FIG. 6 are stored as liquids and are brought into a gaseous state and up to temperature in a heat exchanger (260) that features a radiator (263) to the outside environment. The reactant gases then enter a mixing plenum (250) along with any remaining reactants fed back fed back (261) from the separator (256). After passage through the radiation field, the products are first distilled over (all have boiling points less than water) and the remaining inseparable mix of water and organic product is extracted with an immiscible solvent such as benzene. The products are then distilled out of benzene in anhydrous form and the distillant is returned to the separator reservoir. This is a brief description of how an azeotropic distiller (262) works and is a standard chemist's tool. The spectrometer (246) is set to monitor the raw output of the reaction vessel to better determine product yield via variations in ratios of reactants used.

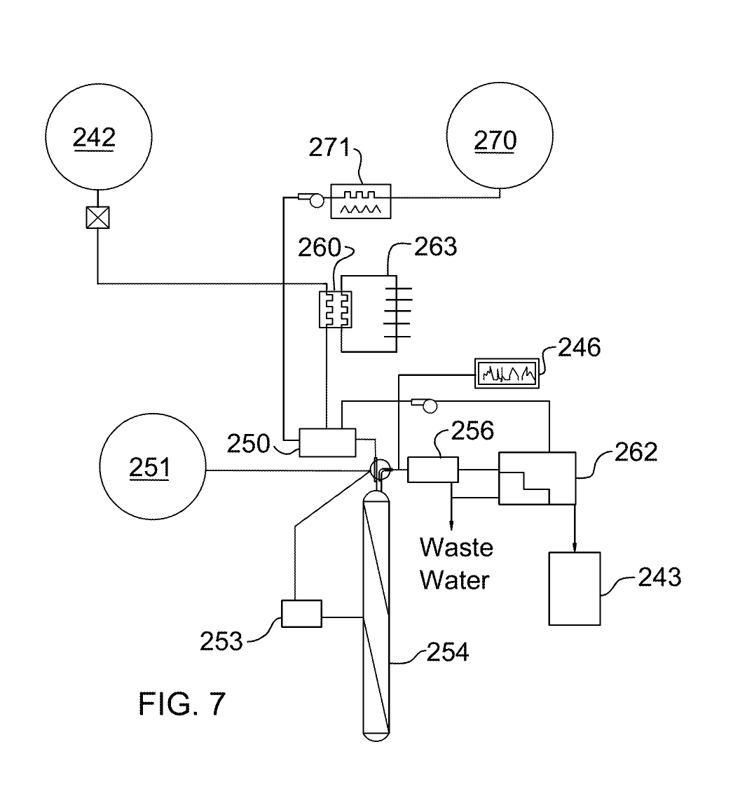

FIG. 7 illustrates a third embodiment of the present system, in which the reactants are carbon dioxide, in tank (242), and secondary or tertiary alcohols, in tank (270). The simplest of these is 2- or 3-propanol (isopropyl alcohol). Carbon dioxide is stored in liquid form changing from liquid to gas in the heat exchanger (247). In contrast with previous plant configurations, the alcohol reactant must be vaporized by a heater (271) before being mixed in the plenum with carbon dioxide gas. Following the chemical reaction in eq. 4, this process produces unsymmetrical ketones that are separated from water in the previously described azeotrope distiller (262). Essentially this plant layout differs from the previous one by showing that one of the reactants is a liquid under standard conditions and must be vaporized before entering the reaction vessel (254).

Although three embodiments of the present system and method have been shown, these are not the only possibilities. For example, more than one reaction vessel can be served by a Tee placed between the emergency control valves of the individual reactors and the mixing plenum. In this configuration, the throughput is a simple multiple of one reaction vessel output, supported by one main supply structure. Depending on the support structure capacity, a half dozen reaction vessels can be operated.

While carbon dioxide reduction is an element of the preferred embodiment, there is a large combination of redox reactions enabled by the radiation field in addition to carbon dioxide.

A practical embodiment of this inventive concept is a profitability model that considers the cost of the reactants and the price of the products. A profitability model example is that of the simplest reaction: hydrogen and carbon dioxide producing carbon monoxide and water. A combination of Compton and photoelectric cross sections for energy transfer into the reactant gas describes the rate of product formation. While the Compton cross section is only concerned with the concentration of electrons per unit volume, the photoelectric cross section is sensitive to the size and charge on the nucleus. This fact arises because the photoelectric cross section becomes large at the lowest energies for which the electron binding energy becomes a significant factor. Fortunately there is a complete tabulation of empirical photoelectric cross sections for all of the elements. Therefore, to consider a particular molecule means assembling the cross sections for the atoms in that molecule on a mole fraction basis.

Gas pressures are high, and it is probable that the perfect gas law must be modified, particularly for molecules with a dipole moment. Therefore, the carbon dioxide equation of state employs a second virial coefficient. Hydrogen, on the other hand, is well described by the perfect gas law.

For a design point of 100 atm carbon dioxide partial pressure at 393 degrees K, the required hydrogen partial pressure is 144 atm in order for it to be present in equi-molar amounts. The composite cross section for the mixture is averaged over the rod energy spectrum and a fraction of the molecules scissioned per second computed based on the deposited gamma ray energy. Recall that the radiant flux in the vessel has been computed by a simple tomographic calculation. In the case of hydrogen and carbon dioxide in equi-molar amounts, and based upon the number of excited fragments per gamma ray, 2.8% of the molecules are cut per second. That means the entire population in the reaction vessel is excited every 35.7 seconds.

Assuming complete separation of carbon monoxide from water with no back reaction and just one reaction vessel, 14.6 metric tonnes of carbon dioxide is consumed along with 0.67 tonnes of hydrogen to produce 9.313 tonnes of carbon monoxide in one 24 hour period. The cost of hydrogen is estimated to be $550/tonne, and carbon dioxide $12/tonne, and the price of carbon monoxide is $1350/tonne. The carbon dioxide price is what the Huaneng Chinese power plant carbon capture unit is advertising. Price of carbon monoxide fluctuates so that the price shown is an average. Further, assuming a plant operating cost of $227 a day for utilities and a single operator, then the net daily profit is shown to be $12,730.

Plant descriptions in FIGS. 5, 6, and 7 show a feedback from the separator (256) to the mixing plenum (250) along with a booster compressor. Feedback reduces output, but ensures purity of the product. Feedback is best expressed as a fraction from 0 to 1 where 1 indicates that the entire output is being fed back (no product). Computation shows that for fractions (0, 0.1, 0.2, 0.3, 0.4, 0.5) the daily net profit fraction is (1, 0.907, 0.83, 0.764, 0.708, 0.659) respectively. Even with 50% feedback the net daily profit is $8,389.

It will be appreciated that such cost models can be constructed for any set of reactants and products for which the costs and prices are known. The physics of the matter consist of computing the composite cross sections, the composite fluid density and the deposition of gamma ray energy. The radiological yield G, according to the NIST table from whence the photoelectric cross sections came, is only 1.1/100 eV whereas some investigators have measured much larger values, between 4 and 5/100 eV for certain reactions.

Turn now to a related question: given that spent nuclear fuel rods represent a valuable radiation source for radiation chemistry, how can one extend the field to others besides owners of cooling ponds? Indeed, if that is possible then it is also possible to construct truly large installations.

The answer to this question already lies with decisions the Nuclear Regulatory Commission has already made: after a sufficient period in a cooling pond, the spent fuel rod assemblies are placed in specially designed casks and shipped to an underground facility where the casks will be safely stored for 300,000 to 500,000 years,

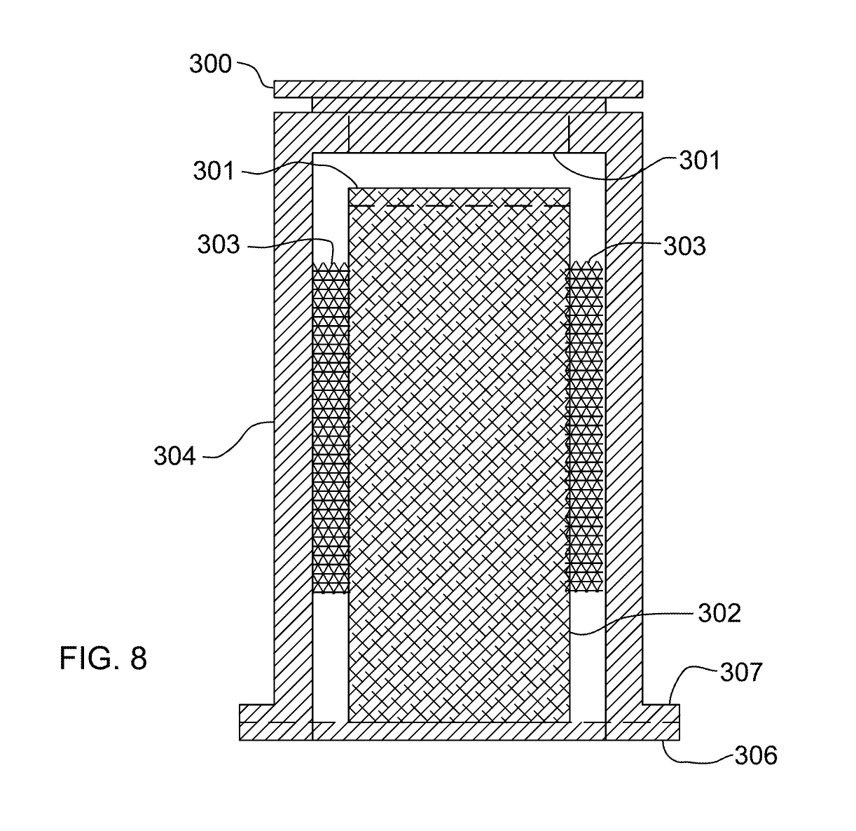

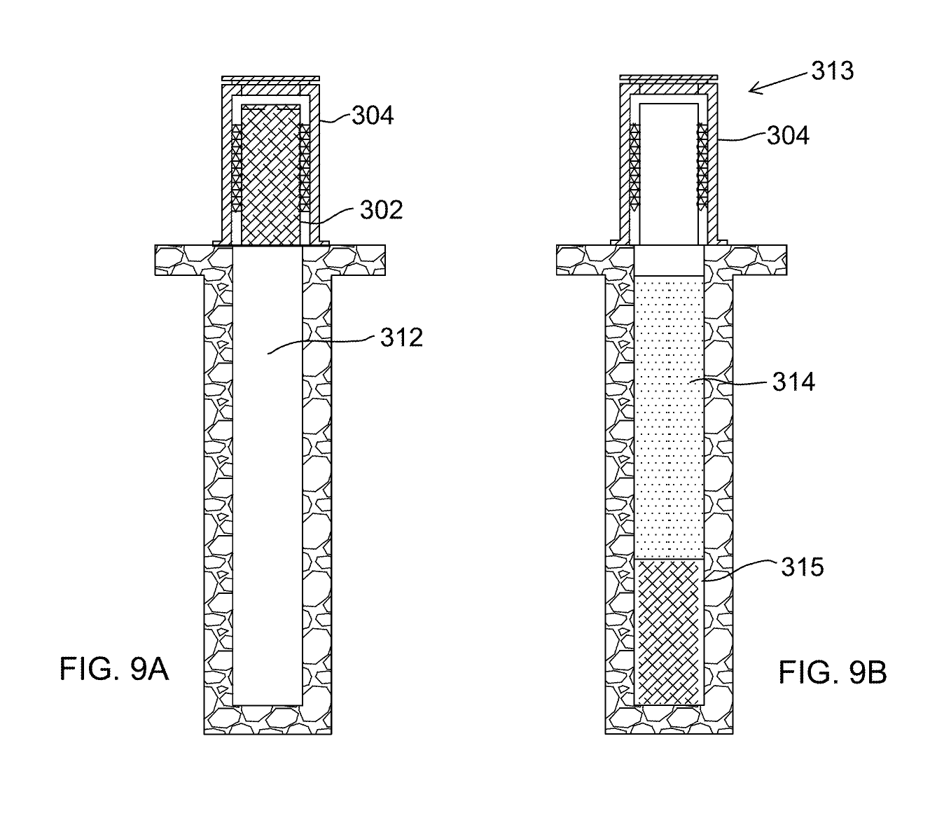

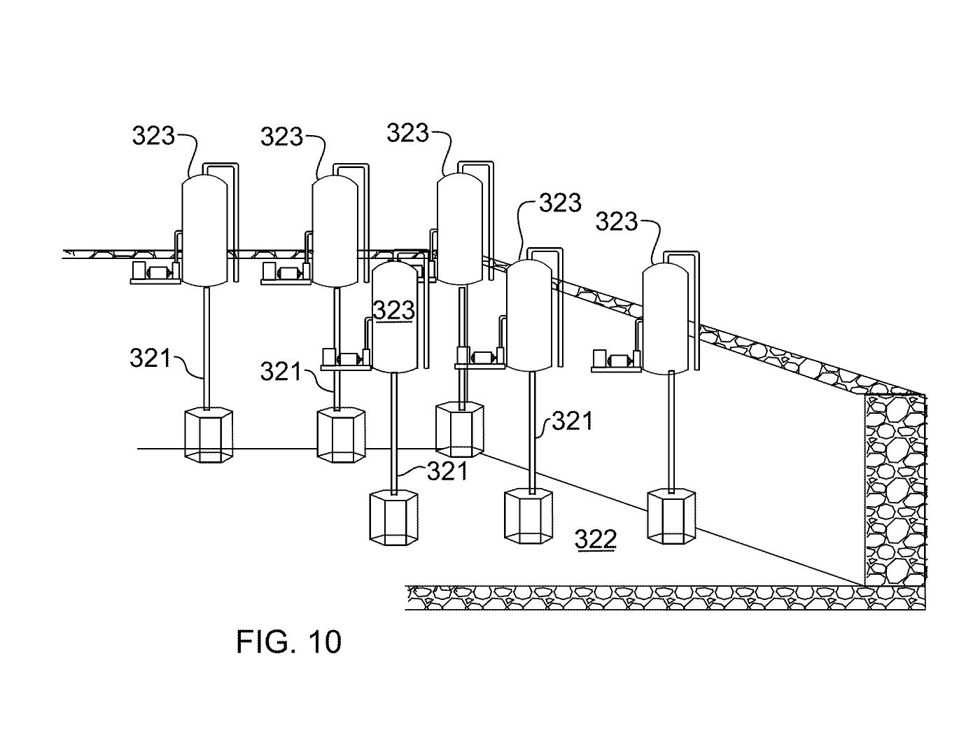

A cask that has already been designed to safely transport a spent fuel rod assembly may be modified with a moveable bottom plate (306), as shown in FIG. 8. Then the modified cask is moved to a prepared deep well, shown in FIG. 9, where it is safely lowered into a deep container (312) of water (314) that provides radiation shielding but still permits access. It is a small step then to consider a consolidation of such wells into a deep pool, FIG. 10 having many spent fuel assembly energy sources to power a chemical plant located above it.

Returning to the detail in FIG. 8, a present vertical midsection of an NRC approved cask design with the spent fuel assembly (with approximately 20 to 300 rods) encased in a steel inner container (302). The outer cask is cement (304). There are access hatches (301) originally designed to be bolted and/or welded in place. A cement cover plate (300) is also provided. Now the present concept is to replace all hatches with bolt-on covers and replace the bottom of the cask with a removable bottom plate (306) bolted in place onto a bottom flange (307) that is added to the present design. The support structure (303) supports and centers the steel inner container, but is modified so that when desired, the inner steel cylinder can be freed and lowered through the bottom exit.

FIG. 9 shows the transport cask poised over a deep well (312) containing water (314). A suitable outer radiation shield is provided with remote viewing such that the outer cask cement lid can be removed and lifted out of place and a crane hoist attached to the inner cylinder. After securing the steel cylinder on a hoist, it is freed from the sides of the cask and a pincer-device remotely slides out the bottom plate. Now, the bottom of the cask is open and facing the surface of the deep water pool. The next view shows the disposition of the steel cylinder containing the spent fuel assembly at the bottom of the water pool (314). Using remote manipulators, the top of the steel cylinder (315) is unbolted and removed. And the cask (313) moved to the side. The pool is open and accessible to emplacement of the reaction vessel(s).

The result of all of these reactions is to recreate the safety of a cooling pond at a location dedicated to chemical processing, as opposed to producing nuclear power. This means that anyone purchasing a spent fuel assembly could conduct chemical manufacture. Of course, safety and licensing considerations are important. But after passing over these hurdles, some 65,000 metric tons of spent nuclear fuel rods now become available as power sources for chemical processing.

It is easy to scale up such a plant. FIG. 10 shows a notional plant built over a pool (322) containing many spent fuel assemblies. The plant is housed in a large building sheltering a collection of processing stations (323) consisting of a compressor pump(s) and a tower containing the product separation unit previously described. Two flexible pipes for input and output gases (321) connect each processing station with reaction vessels nestled in the spent fuel assemblies. Not shown are the sensor wires nor the tank farm outside the facility containing reactants and products. There is no limit to the size of such a plant; it could easily rival conventional chemical plants. But, most importantly, such a facility need not have any connection with the nuclear power industry broadening the base of this concept into what will be a completely new chemical industry.

Fuel rods lose some radioactivity with time, particularly within the first five or ten years. Therefore it is advantageous to have a flexible arrangement of fuel rods and reaction vessels that compensate for this radioactivity decline. FIGS. 11A-D is one realization of how to place and use eight reaction vessels around a typical spent fuel rod assembly arranged in a square array of 17 fuel rods on a side for a total of 289 rods. FIGS. 11A-C show a top view of the arrangement differing only in how the reaction vessels are connected with external sources and sinks. FIG. 11D is a side view of half the reaction vessels. The figure is not drawn to scale; the ratio of the length to the diameter of the reaction vessels is about 33 to 1.

There are at least three ways the vessels can be connected together: ganged in four groups of two units each as in FIG. 11C; ganged in two groups of four units each as in FIG. 11B and lastly ganged in one group as in FIG. 11A. These choices are essential to trade off throughput rate versus yield. If, for example the product yield is excellent for two sets of four vessels (FIG. 11B), then use the arrangement of FIG. 11c to run four sets of two vessel each to increase the yield rate by a factor of two. Conversely, if the yield is less than expected, turn to the arrangement of FIG. 11A to give the reactants more time in the radiation field by a factor of two.

In detail, the top view of the fuel rod assembly (400) is the square array in the center. The reaction vessels are uniformly distributed on a circle with a radius greater than the sum of the array diagonal and the vessel radius. The pipes connecting the bottom of the vessels are in outline form, whereas the pipes connecting the vessel tops are shown filled in. The reaction vessel array side view (406) illustrates the pipe connections shown in the top view, FIG. 11B. Fluids enter and leave the vessel array through the top at (407) and (408). These are variable as shown in FIGS. 11a-11c.

The flexibility of this arrangement of a fuel rod assembly and reaction vessels will be especially desirable in the chemical plant configuration shown in FIG. 10. A production engineer could decide to have one arrangement to produce ketones and another to optimally produce alcohols assigned separately to each fuel rod assembly in the plant. Thus all would be producing a chemical variety at an optimal rate with high product purity.

It is assumed in this disclosure that carbon dioxide is supplied to the plant process in liquid form; not for any fundamental reason, but because transport from the source is easier. Since carbon dioxide reacts with titrants in the gas phase, any form of the substance: solid liquid or gas can be used.

In situ capture and sequestration of carbon dioxide is a variant of our basic patent idea but the radiochemistry will only work if oxygen is removed from the gas before processing. There are well-known, commercial ways of performing this separation, the first is compression, cooling and expansion through a Joule-Thompson orifice, i.e., a standard refrigeration method. Carbon dioxide is removed as a solid. Additionally, there are commercially available membranes that separate carbon dioxide from the other atmospheric gases in a two or three-stage diffusor. If oxygen concentrations are deemed too high after membrane separation, the exiting gas is passed over a getter material , such as mixed oxides of manganese an iron to remove the excess oxygen. In either case, carbon dioxide is delivered to our apparatus and is reduced by the action of the gamma ray absorption in the presence of other titrants, just as previously described.

Adding this carbon dioxide/atmosphere separation step using commercial technology, now solves both the capture and sequestration of carbon dioxide in just one step. The quality of the chemical products made from it is not affected by this approach, but the chemical production rate certainly is because of the low carbon dioxide concentration in the atmosphere. Still, it is a less costly way of capturing and sequestering carbon dioxide for the same reason as before; the needed chemical transformation energy is taken from the gamma radiation field. It's ‘carbon footprint’ will be limited to the electrical power needed to run the refrigerator compressor or other separation process.

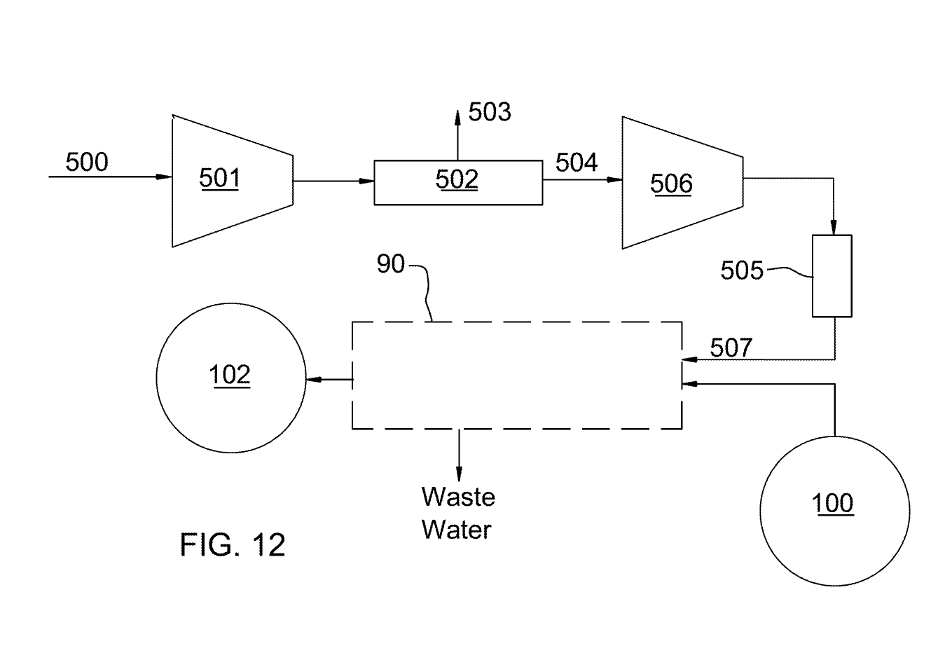

Turn now to FIG. 12 for a more detailed description. Atmospheric air (500), containing carbon dioxide is admitted to a compressor (501) where it is compressed as required by the next device, the separator (502). As described above, the separator (502) can either be a refrigerator device, or a permeable membrane device, although the latter is preferred because its energy use is significantly less than a refrigerator. The separator (502) separates out the carbon dioxide (504) that is passed to another compressor and the ‘scrubbed air’ (503) is returned to the atmosphere. Optionally, an oxygen scrubber (505) or getter may be located following post separation compression at compressor (506). Following that stage, if needed, the pure carbon dioxide (507) is admitted to the plant along with a suitable reactant from tank (100) as described in the plant (90) of FIG. 1 and all subsequent figures pertaining to the plant details. In effect, this sequence of devices for producing carbon dioxide replaces the carbon dioxide tank (101) as shown in FIG. 1. When dry cask transport is permitted, then these carbon dioxide capture stations can be located anywhere the requisite site for the spent fuel rod assemblies are sited.

The present system and method provide a practical process for reducing carbon dioxide to a variety of chemicals by means of gamma radiation from spent fuel rods is described. No catalysts are required, nor is there any thermodynamic limit on the product production rate. The reaction vessel, placed in close proximity to the fuel rod(s) is designed to withstand high gas operating pressures, be safe and yet be transparent as possible to the gamma radiation field.

Although the present system and method has been described in considerable detail with reference to certain preferred versions thereof, other versions are possible. Therefore the spirit and scope of the appended claims should not be limited to the description of the preferred versions contained therein.

What is claimed is:

1. A reactor vessel for reducing a mixture of carbon dioxide and a reactant to a product by exposure to gamma radiation, the system comprising:
a wall enclosing an interior space, the wall being constructed of a material that permits a substantial portion of the incident gamma radiation to pass through the wall;
an inlet tube for introducing the mixture of carbon dioxide and the reactant into the interior space; and
an outlet tube for transporting the product out of the interior space;
wherein at least a portion of the wall is configured to be in sufficient proximity to a gamma radiation source for reacting the mixture flowing through the interior space from the inlet tube to the outlet tube.

2. The reactor vessel of claim 1 wherein at least a portion of the wall is comprised of one of a carbon fiber material and a silicon material.

3. The reactor vessel of claim 2 wherein the portion of the wall is comprised of the carbon fiber material, and an optical fiber strain sensor is wrapped about at least a portion of the wall, and is embedded within the carbon fiber material.

4. The reactor vessel of claim 1 wherein the wall is substantially cylindrical in shape and having a bottom portion.

5. The reactor vessel of claim 4 wherein the inlet tube extends into the interior space and towards the bottom portion.

6. The reactor vessel of claim 5 wherein an open end of the inlet tube terminates at a distance from the bottom portion, the distance being sufficient to substantially reduce acoustic vibration due to turbulence.

7. The reactor vessel of claim 6 wherein the distance is equal to approximately ten times a diameter of the inlet tube.

8. The reactor vessel of claim 5 wherein a bushing is positioned between an interior surface of the wall and an outer diameter of the inlet tube, the bushing damping vibration of the inlet tube.

9. The reactor vessel of claim 8 wherein the bushing comprises an inner ring, an outer ring, and a plurality of spokes connecting the inner ring to the outer ring, the inner ring being fitted about the outer diameter of the inlet tube and the outer ring being fitted against the interior surface of the wall, to substantially prevent movement of the inlet tube.

10. The reactor vessel of claim 2 wherein the wall is made of carbon fiber with a polymer coating on an interior surface of the wall and a fiberglass wrap on an exterior surface of the wall.

11. The reactor vessel of claim 1 wherein the wall is constructed of a material that substantially transparent to gamma radiation.

12. The reactor vessel of claim 1 wherein the portion of the wall is approximately one centimeter to ten centimeters away from the gamma radiation source.

13. A method of reducing carbon dioxide and a reactant into a product, the method comprising the steps of:
providing a reactor vessel comprising a wall that us substantially transparent to gamma radiation and enclosing an interior space, an inlet tube, and an outlet tube;
locating the reactor vessel in proximity to at least one radioactive fuel rod;
mixing carbon dioxide with a reactant to create a mixture;
flowing the mixture through the inlet tube and into the interior space;
reacting the mixture with the gamma radiation emitted by the radioactive fuel rod to produce a product; and
flowing the product out of the interior space through the outlet tube.

14. The method of claim 13 wherein the reactor vessel is an elongated cylinder with a bottom portion, the inlet tube extends into the interior space and towards the bottom portion, an open end of the inlet tube terminates at a distance from the bottom portion.

15. The method of claim 13 wherein the step of locating the reactor vessel in proximity to at least one radioactive fuel rod further comprises locating the reactor vessel within an array of radioactive fuel rods, the reactor vessel being positioned sufficiently close for adequate exposure to the gamma radiation to permit a reaction between the carbon dioxide and the reactant, and the reactor vessel being positioned sufficiently distant to provide space for cooling water flow between the reactor vessel and each of the radioactive fuel rods with the array of radioactive fuel rods.

16. The method of claim 14 further comprising the steps of:
flowing the mixture through the inlet tube and out of the open end;
reversing a flow direction of the mixture once exiting the open end; and
flowing the mixture between an interior surface of the wall and an outer diameter of the inlet tube before the step of flowing the product out of the interior space through the outlet tube.

17. The method of claim 13 further comprising the step of:
transporting the product to a water separator for extracting water.

18. The method of claim 13 further comprising the steps of:
embedding within the carbon fiber material an optical fiber strain sensor;
sensing a failure event;
activating an emergency control valve to substantially empty the reactor vessel of one or all of the carbon dioxide, the reactant, and the product; and
transporting one or all of the carbon dioxide, the reactant, and the product to the emergency dump tank.

19. The method of claim 13 wherein the reactant is hydrogen and the product is of carbon monoxide, or the reactant is one or more of an alkane and an alkene, and the product is one or more of carbon monoxide, alcohols, aldehydes, and ketones, or the reactant is one or more of secondary and tertiary alcohols, and the product is unsymmetrical ketones.

20. The method of claim 13 wherein a wall of the reactor vessel is approximately one centimeter to ten centimeters away from the at least one radioactive fuel rod.
